(19) United States
(12) Patent Application Publication
(10) Pub. No.: US 2008/0082826 A1
(43) Pub. Date: Apr. 3, 2008

(54) Method and apparatus for updating non-volatile memories

(76) Inventor: Brent Ahlquist, Loomis, CA (US)

Correspondence Address: LEE & HAYES, PLLC, P.O. BOX 52050, MINNEAPOLIS, MN, 55402, US

(21) Appl. No.: 11/541,231

(22) Filed: Sep. 29, 2006

(51) Int. Cl. H04L 9/00; G06F 12/14; H04L 9/32; G06F 11/30

(52) U.S. Cl. 713/176; 713/181; 713/187

(57) ABSTRACT

An authenticatable envelope is utilized to allow for the secure and quasi-atomic delivery and execution of an ordered list of externally specified non-volatile memory write commands. In at least some embodiments, an external provider generates an authenticatable envelope that includes write commands and data that is used by a local platform of a non-volatile memory device to generate non-volatile memory write data in response to the write commands.

### BACKGROUND

Many portable computing and communication devices, such as laptops, portable digital assistants (PDAs), cellular phones and other related devices, utilize a form of non-volatile memory. One type of non-volatile memory is flash memory. Flash memory may be used by these devices to store operating systems and various application programs. It is often desirable for an external provider to provide updates for an operating system or application program that is stored in a device's flash memory. Yet, updating a device's flash memory can sometimes be an inefficient and insecure process.

Specifically, many processes that allow an external provider to update a device's flash memory require the device's local platform to manage the entire update process, and this process is not end-to-end secure. These processes are vulnerable to data corruption from malware that may be present on a device's local platform or from signal loss due to a power loss scenario. Additionally, many update approaches employ proprietary differencing and compression algorithms that are performance and resource intensive and thus are not conducive to widespread integration into the flash memory platform.

### BRIEF DESCRIPTION OF THE DRAWINGS

FIG. 1 illustrates an exemplary delivery of an authenticatable envelope in accordance with one embodiment.

FIG. 2 illustrates the components of an exemplary authenticatable envelope in accordance with one embodiment.

FIG. 3 illustrates the components of an exemplary sub-command element list in accordance with one embodiment.

FIG. 4 is a flow diagram that describes acts in a method in accordance with one embodiment.

FIG. 5 is a flow diagram that describes acts in an exemplary implementation in accordance with one embodiment.

FIG. 6 illustrates an exemplary electronic system that can utilize non-volatile memories.

### DETAILED DESCRIPTION

In the embodiments described below, systems and methods are described for the secure and quasi-atomic delivery and execution of an ordered list of externally specified write sub-commands in a computing device that utilizes a form of non-volatile memory (hereinafter “computing device”). A computing device can include, by way of example and not limitation, a cell phone, a portable digital assistant, a laptop, or any other device which utilizes a form of non-volatile memory (NVM). These systems and methods can utilize the local platform of a computing device to generate write data based on the externally specified write sub-commands. In at least some embodiments, the write data may comprise an update to an operating system or an application program that resides on the NVM of a computing device. The quasi-atomic aspect of these updates is important to the proper functionality of a computing device. For example, if an update fails to be atomic, an invalid state may occur on the computing device that may result in some type of device malfunction or decreased functionality. Thus, certain embodiments discussed below allow the externally specified write sub-commands to be executed in a quasi-atomic fashion, while also allowing the local platform of the computing device to generate the write data from the write sub-commands.

Further to these systems and methods, an authenticatable envelope structure is introduced. The authenticatable envelope allows an external provider to compile write sub-commands and any complementary data into a secure package that can then be transmitted to and processed by a computing device. As employed herein, and in some embodiments, the term sub-command indicates a command that is contained within the authenticatable envelope. The authenticatable envelope can be employed across multiple platforms, and can thus allow an external provider and a computing device to support proprietary differencing and compression techniques that may be unknown to the NVM of the computing device.

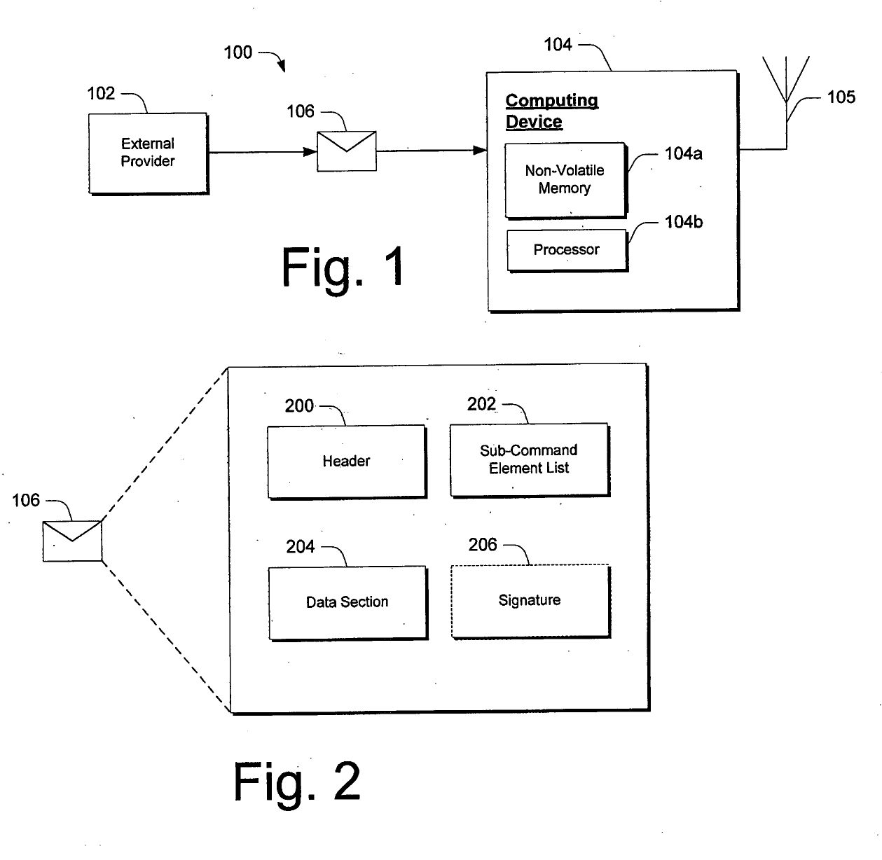

As a broad overview of the discussion that follows, consider FIG. 1, which illustrates general aspects of the embodiments discussed herein at 100. There, an external provider 102 first determines one or more NVM sub-commands that are to be executed on a computing device 104. An external provider can comprise any suitable entity that can provide updates or other commands to a computing device. For example, an external provider can include, by way of example and not limitation, a cell phone service provider, a manufacturer of a PDA or other similar device that utilizes a form of non-volatile memory, or the developer of an operating system or application program that resides on the NVM of a computing device.

The external provider 102 can compile the NVM sub-commands and any accompanying data into an authenticatable envelope 106, which provides a secure and authenticatable way of delivering a payload to the computing device. The authenticatable envelope 106 is then transmitted by the external provider 102, or some other intermediary entity, to the computing device 104. In this embodiment, computing device 104 comprises a non-volatile memory 104a, a processor 104b and an antenna 105. The computing device 104 can then authenticate the authenticatable envelope 106 using a suitable authentication method. Such suitable methods may include, but are not limited to, RSA authentication or the use of a hashed message authentication code. However, other means of authentication may be utilized that are well known to those of skill in the art. If the authenticatable envelope 106 is successfully authenticated, the computing device 104 can then process the authenticated envelope to discover and act upon the information that is contained in the envelope. In at least some embodiments, this information includes one or more NVM sub-commands that can be used to update or otherwise configure or re-configure the NVM of the computing device. Finally, computing device 104 can then execute the NVM sub-commands to generate write data that corresponds to the NVM sub-commands.

Exemplary Authenticatable Envelope

As introduced above, an authenticatable envelope is used to convey information to a computing device. The authenticable envelope is a logical entity which, in at least some embodiments, allows one or more NVM write sub-commands to be delivered for execution by a computing device in a quasi-atomic and secure fashion. To this end, the authenticatable envelope further can ensure that execution of its NVM write sub-commands is completed in the event of the occurrence of certain contingencies, such as in the event of a power loss scenario, as will become apparent below.

As but one exemplary embodiment, consider FIG. 2, which illustrates an exemplary authenticatable envelope 106. Authenticatable envelope 106 comprises header 200, a sub-command element list 202, a data section 204, and optionally, a signature 206.

Header 200 is used by authenticatable envelope 106, in this particular example, to maintain detailed authenticatable envelope format specification information. Such information can include, by way of example and not limitation, a sub-command element count that specifies the number of NVM sub-command elements contained within the authenticatable envelope.

Sub-command element list 202 comprises the NVM sub-command elements that are contained within the authenticatable envelope. This aspect of the authenticatable envelope is discussed in more detail below.

Data section 204 comprises data that communicates to the local platform of a computing device the necessary information to generate write data from the NVM write sub-commands contained within authenticatable envelope 106. As mentioned above, in generating NVM write data, the local platform of the computing device may utilize proprietary differencing, compression, or other similar techniques that may be unknown to the NVM of the computing device. Thus, in some embodiments, data section 204 contains data that allows one or more of these techniques to be utilized by the local platform of the computing device to generate NVM write data from the NVM sub-commands contained within the authenticatable envelope. In some embodiments, data section 204 may contain difference files that are utilized by the local platform of the computing device to generate NVM write data. Alternatively or additionally, data section 204 may contain the NVM write data itself. However, these described embodiments are not intended to be limiting, and data section 204 may contain data in any format that may be interpreted by the local platform of a computing device to generate NVM write data.

Finally, in some embodiments the authenticatable envelope 106 may contain a signature 206 that is utilized by the computing device to authenticate the authenticatable envelope. In alternate embodiments, the signature may be transmitted to the computing device separately from the authenticatable envelope.

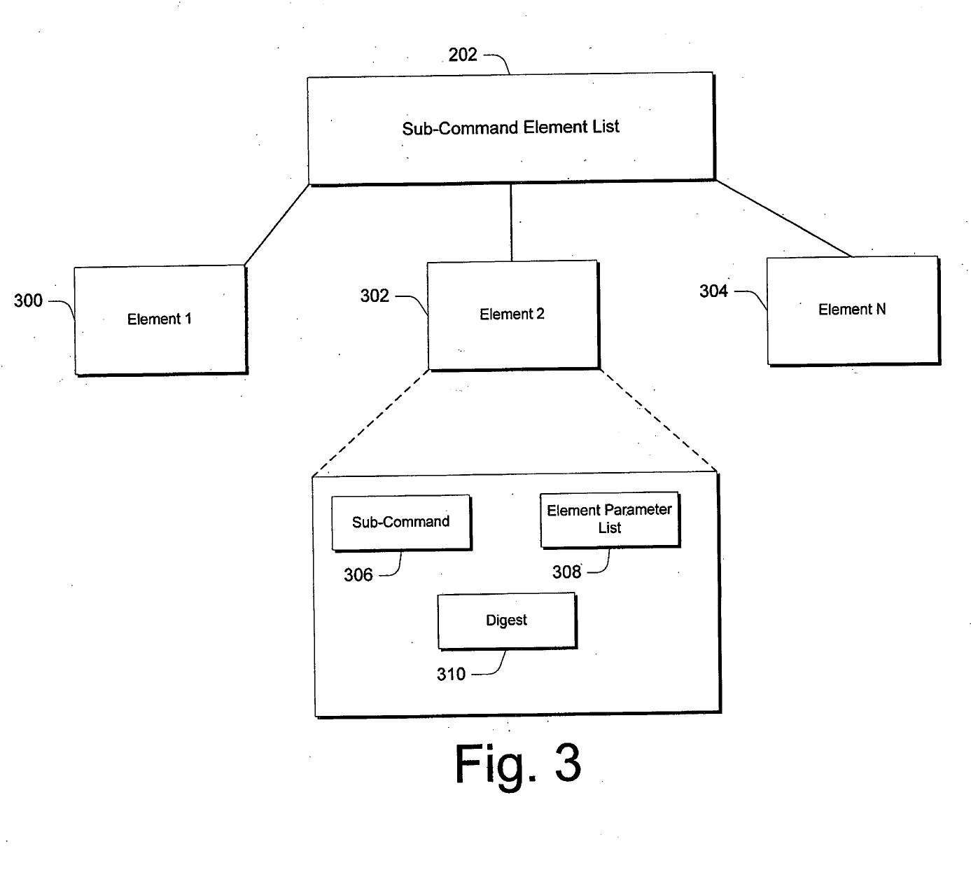

Further to this discussion of the authenticatable envelope, FIG. 3 illustrates an exemplary embodiment of sub-command element list 202 that can be contained within the authenticatable envelope. Sub-command element list 202 comprises one or more sub-command elements such as, in this example, sub-command element 300, sub-command element 302, and sub-command element 304. While FIG. 3 illustrates a sub-command element list comprising three sub-command elements, a sub-command element list may contain any number of sub-command elements.

FIG. 3 further illustrates the components of an exemplary sub-command element 302 in accordance with one embodiment. Command element 302 comprises, in this particular example, one or more NVM write sub-commands 306, an element parameter list 308, and a digest 310. The NVM write sub-command(s) 306 contain operation code that allows the NVM write sub-commands to be executed on a computing device. The element parameter list 308 contains sub-command parameter specifications that will be utilized by the computing device to execute the NVM write sub-commands. The digest 310 comprises a digest of the write sub-commands 306, the sub-command element parameters contained in the element parameter list 308, and the write data that will be generated by the computing device as a result of executing the NVM write sub-commands that are contained in the sub-command element 302. In some embodiments, digest 310 is generated by applying a hash function to the above-mentioned data. However, this is not intended to limit this feature, and other suitable methods may be employed to generate digest 310.

Exemplary Method

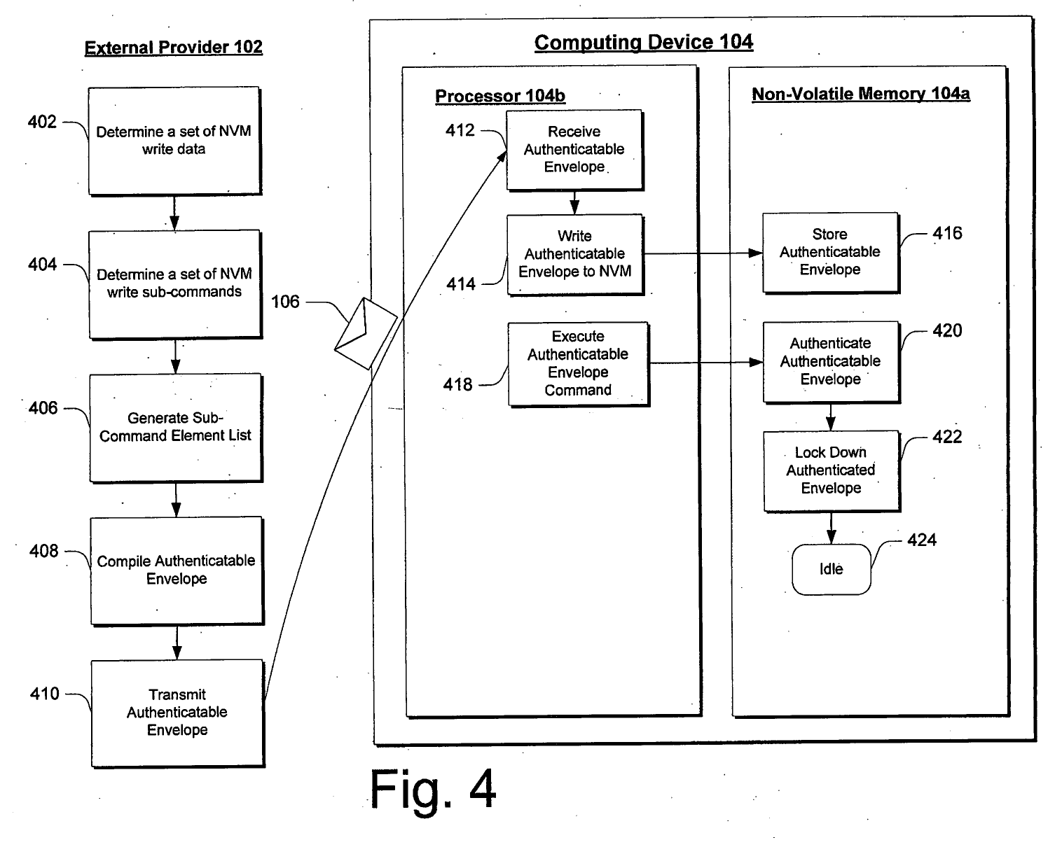

FIG. 4 is a flow diagram that describes acts in a method in accordance with one embodiment. In this particular embodiment, acts 402-410 are performed by an external provider, such as the one described above, and acts 412-424 are performed by a computing device. This example further indicates that certain acts may occur on the processor of the computing device, while others may occur on the NVM itself. This segregation of acts into separate regions of the computing device is for purposes of this example only, and is not intended to be limiting.

Act 402 determines a set of NVM write data to be generated by a computing device. Act 404 determines a set of NVM write sub-commands that can be utilized to by the computing device to generate the NVM write data. Act 406 generates a sub-command element list based at least in part on the NVM sub-commands and the NVM write data. An exemplary embodiment of a sub-command element list is discussed above with respect to FIG. 3. Act 408 compiles various data, including the sub-command element list, into an authenticatable envelope. An exemplary embodiment of an authenticatable envelope is discussed above with respect to FIG. 2. Other types of authenticable envelopes can be used without departing from the spirit and scope of the claimed subject matter. Act 410 transmits the authenticatable envelope 106 from the external provider to the computing device.

Act 412 receives the authenticatable envelope into the processor, or local platform, of the computing device. Act 414 causes the processor to write the authenticatable envelope to the NVM of the computing device. Act 416 stores the authenticatable envelope on the NVM of the computing device. Although not explicitly illustrated here, in some embodiments the NVM of the computing device enters an idle state after storing the authenticatable envelope. Act 418 executes an authenticatable envelope command which, in some embodiments, provides the NVM of the computing device with the necessary information to authenticate the authenticatable envelope. In some embodiments, this necessary information includes a signature that is associated with the authenticatable envelope. At act 420, the NVM of the computing device authenticates the authenticatable envelope. As discussed above, the authentication may be facilitated in some embodiments by a signature that is generated by the external provider. The signature may optionally be part of the authenticatable envelope or, in alternate embodiments, may be received by the computing device separately from the authenticatable envelope. In still other embodiments, the act of authentication may utilize other suitable methods that do not utilize a signature from the external provider.

At act 422, the authenticated envelope is locked down so that its contents cannot be modified. In some embodiments, act 422 occurs in the NVM of the computing device. Locking down the authenticated envelope may involve, in certain embodiments, changing the authenticated envelope status to read-only. According to some embodiments, the local platform of the computing device may utilize one or more reference structures in processing the contents of the authenticated envelope. A reference structure can be a scatter gather list that allows the contents of the authenticated envelope to be divided into smaller pieces and stored in the NVM of the computing device. The scatter gather list keeps track of the location of any authenticated envelope pieces in the NVM, as well as other related data. In such embodiments, the reference structures would also be locked down. Further to act 422, and in some embodiments, the NVM of the computing device creates one or more non-volatile data structures that may be used by the computing device to track the authenticated envelope's execution progress. According to some embodiments, the non-volatile data structures may be used in the event of a power loss scenario to complete execution of the authenticated envelope. This feature is discussed in more detail below.

At act 424, and further to some embodiments, the NVM of the computing device enters an idle state while it waits for the processor of the computing device to initiate the process of executing the sub-commands contained within the authenticated envelope.

Implementation Example

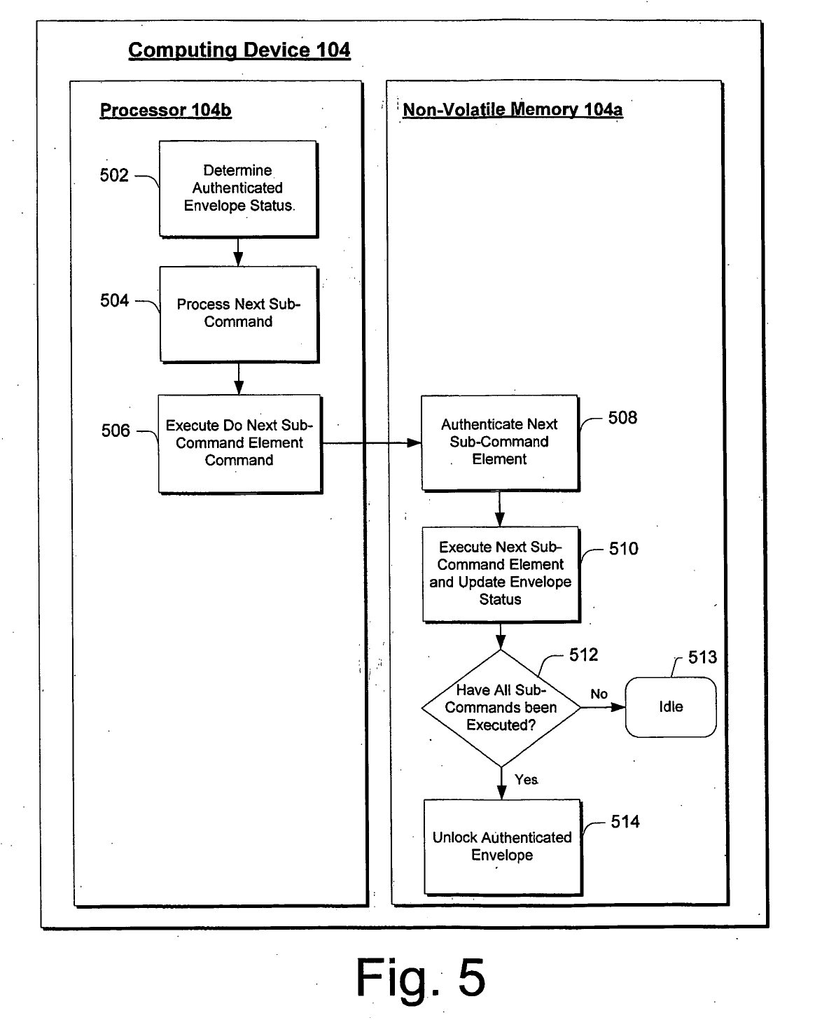

FIG. 5 is a flow diagram of an exemplary method in accordance with one embodiment. This example assumes that the authenticated envelope has already been received, authenticated and locked-down by a computing device, as discussed above with respect to certain exemplary embodiments. This example further indicates that certain acts may occur on the processor of the computing device, while others may occur on the NVM itself. This segregation of acts into separate regions of the computing device is for purposes of this example only, and is not intended to be limiting.

At act 502, the local platform of a computing device determines the status of the authenticated envelope, i.e., which NVM sub-command elements remain to be executed in the authenticated envelope. If the computing device is recovering from a power loss scenario, act 502 may include executing a get envelope status command in order to retrieve authenticated envelope state information so that the authenticated envelope may continue to be executed. In some embodiments, the get envelope status command causes the local platform to ascertain the execution status of the authenticated envelope, the location of the authenticated envelope on the NVM of the computing device, along with the next NVM sub-command that is to be executed. This may include accessing one or more non-volatile data structures, as discussed above with respect to FIG. 4. In a continuous power context, the local platform of the computing device would be aware of the authenticated envelope status and thus would not require the execution of a get envelope status command. In some embodiments, act 502 occurs on the processor of the computing device and in some embodiments, an idle state follows act 502 until the processor can begin processing the next sub-command.

Act 504 processes the authenticated envelope in order to ascertain the next NVM sub-command to be executed and to generate NVM sub-command data from data contained in the authenticated envelope. In some embodiments, and as part of act 504, the processor of the computing device uses data from the authenticated envelope to construct sub-command element data to be provided as an address in a do next sub-command element command. In some embodiments, there is an idle state that follows act 504 and awaits the execution of the do next sub-command element command. At act 506, the processor of the computing device executes a do next sub-command element command, including the appropriate data or reference structure address, on the NVM of the computing device. In some embodiments, there is an idle state that follows act 506 until the NVM is ready for another sub-command element. Act 508 locates the sub-command element(s) and authenticates the sub-command element(s) using a suitable authentication method. In one embodiment, act 508 includes creating a digest of the NVM sub-command, NVM sub-command parameters, and the NVM data generated by the processor from data within the authenticated envelope. This digest is then compared to a preexisting digest that is contained in the corresponding sub-command element list within the authenticated envelope. An exemplary sub-command element list is discussed above with respect to FIG. 3. If the created digest and the preexisting digest are identical, then the NVM sub-command is authenticated. In some embodiments, act 508 occurs on the NVM of the computing device. Act 510 executes the authenticated NVM sub-command and updates the authenticated envelope status to indicate that the NVM sub-command has been completed. In some embodiments, act 510 includes writing, to the NVM, the NVM sub-command data that was generated in act 504. In some embodiments, act 510 occurs on the NVM of the computing device. Act 512 determines if all of the NVM sub-commands within the authenticated envelope have been completed. If all of the NVM sub-commands have not been completed, the system is idle at act 513 until the next sub-command is received. If all of the NVM sub-commands have been completed, act 514 unlocks the authenticated envelope and/or any reference structure(s). In some embodiments, act 514 includes removing write protection from the authenticated envelope and/or reference structure(s). In some embodiments, act 514 occurs on the NVM of the computing device.

Further to the quasi-atomic nature of the discussed NVM write process, the embodiment disclosed in FIG. 5 is an iterative process that allows the NVM write data to be constructed from the contents of the authenticated envelope. For example, the local platform of a computing device would continue to generate NVM sub-command data (e.g. act 504) as long as unexecuted sub-command elements remain within the authenticated envelope. Thus, one of the significant aspects of at least some discussed embodiments is the fact that within the locked-down authenticated envelope is contained all of the required information to iteratively reconstruct the NVM write data to be written by the authenticated envelope sub-commands contained in a command element list. Accordingly, and by way of example and not limitation, if an authenticated envelope contains a compressed difference file, then the total NVM space required at any time to construct the final NVM image associated with that file comprises the authenticated envelope data (in this case, the compressed difference file) and the associated NVM sub-command data. As is apparent from the discussed examples, and in some embodiments, the NVM write process is initiated and supported by the local platform of a computing device, and thus the NVM of the computing device is not itself required to interpret the data contained within the authenticated envelope.

Although not explicitly illustrated in this example, certain embodiments also support an abort authenticated envelope feature. This feature allows the execution of the authenticated envelope to be aborted should one or more errors be detected in the contents of the authenticated envelope. In certain embodiments, upon detection of one or more errors in the authenticated envelope, the authenticated envelope abort feature aborts the execution of the authenticated envelope, unlocks the authenticated envelope, and then closes the authenticated envelope. Closing the authenticated envelope prevents the error-containing authenticated envelope from being executed on a computing device.

Power Loss Recovery

In some embodiments, the computing device maintains an authenticated envelope power loss recovery (PLR) state machine. The PLR state machine is associated with the execution of the NVM sub-commands contained within an authenticated envelope, and can ensure that in the event of a computing device power loss event or similar scenario, remaining unexecuted NVM sub-commands can subsequently be executed when power is restored to the computing device. In one embodiment, the PLR state machine is maintained by creating, on the computing device, a non-volatile state for an authenticated envelope. Creation of the non-volatile state can include writing to the NVM of the computing device desired information for the execution of a get envelope status command by the computing device's local platform. The desired information can include the NVM address for the authenticated envelope and an authenticated envelope sub-command element index. Thus, in some embodiments, when the computing device is recovering from a power loss event, the local platform of the computing device can execute a get envelope status command in order to retrieve the authenticated envelope address in the computing device's NVM and the sub-command element index. The sub-command element index increments when an NVM sub-command is successfully executed and thus allows the PLR state machine to determine which NVM sub-commands have yet to be executed. This permits the local platform to continue executing the authenticated envelope should a power loss event disrupt the authenticated envelope execution process.

Exemplary System

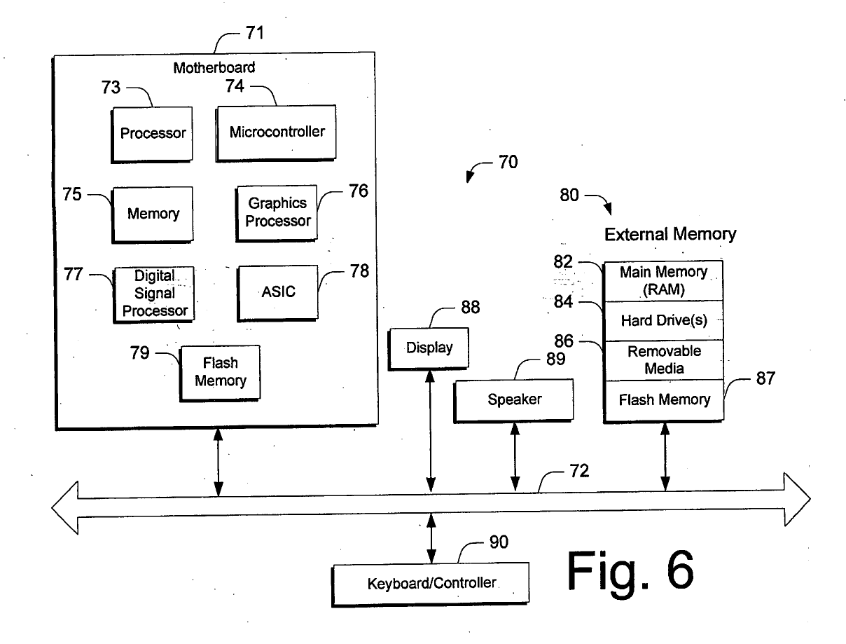

Referring to FIG. 6, a block diagram of an exemplary electronic system that can utilize non-volatile memories such as those described above is shown generally at 70. Such electronic system can comprise a computer system that includes a motherboard 71 which is electrically coupled to various components in electronic system 70 via a system bus 72. System bus 72 may be a single bus or any combination of busses.

Motherboard 71 can include, among other components, one or more processors 73, a microcontroller 74, memory 75, a graphics processor 76 or a digital signal processor 77, and/or a custom circuit or an application-specific integrated circuit 78, such as a communications circuit for use in wireless devices such as cellular telephones, pagers, portable computers, two-way radios, and similar electronic systems and a flash memory device 79.

The electronic system 70 may also include an external memory 80 that in turn includes one or more memory elements suitable to the particular application, such as a main memory 82 in the form of random access memory (RAM), one or more hard drives 84, and/or one or more drives that handle removable media 86, such as floppy diskettes, compact disks (CDs) and digital video disks (DVDs). In addition, such external memory may also include a flash memory device 87.

The electronic system 70 may also include a display device 88, a speaker 89, and a controller 90, such as a keyboard, mouse, trackball, game controller, microphone, voice-recognition device, or any other device that inputs information into the electronic system 70.

Conclusion

The above-described systems and methods allow for the secure and quasi-atomic delivery and execution of an ordered list of externally specified NVM write sub-commands. In at least some embodiments, these systems and methods can utilize the local platform of a computing device to generate NVM write data.

Although the embodiments have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

What is claimed is:

1. A method comprising updating a non-volatile memory on a device using an authenticated authenticatable envelope that contains one or more executable update commands.

2. A method as recited in claim 1, further comprising locking down the authenticated authenticatable envelope so that it cannot be modified.

3. A method as recited in claim 1, wherein authentication of the authenticatable envelope comprises receiving a signature from externally of the device and using the signature to authenticate the authenticatable envelope, wherein the signature comprises part of the authenticatable envelope.

4. A method as recited in claim 1, further comprising maintaining a state machine associated with execution of the one or more executable update commands.

5. A method as recited in claim 4, wherein maintaining the state machine comprises recording an address of the authenticated authenticatable envelope and recording a command element index.

6. A method as recited in claim 4, further comprising, responsive to a power loss, retrieving authenticated authenticatable envelope status information.

7. A method as recited in claim 1, further comprising authenticating a command element by:
obtaining a first digest from the authenticated authenticatable envelope;
creating, on the device, a second digest associated with the command element; and
comparing said second digest with said first digest.

8. A method as recited in claim 7, wherein said first digest comprises a digest of the executable update commands, executable update command parameters, and command data generated in response to the executable update commands.

9. A method as recited in claim 1, wherein the authenticatable envelope contains one or more difference files.

10. A method as recited in claim 1, wherein the authenticatable envelope is received from an external provider, and wherein the device may utilize one or more procedures to interpret data within the authenticatable envelope, wherein the data is used to update the non-volatile memory, and wherein the one or more procedures are unknown to the non-volatile memory.

11. One or more computer-readable media having stored thereon a computer program that, when executed by one or more processors of a computer, causes the one or more processors to perform acts comprising:
assembling an authenticatable envelope, wherein the authenticatable envelope comprises information that can be used to update a non-volatile memory; and
transmitting the authenticatable envelope to a device that contains the non-volatile memory.

12. The one or more computer readable media as recited in claim 11, wherein the information comprises a command element list.

13. The one or more computer readable media as recited in claim 11, wherein the information comprises data that can be used to generate write data for commands in the authenticatable envelope.

14. The one or more computer readable media as recited in claim 11, wherein the information comprises a signature.

15. The one or more computer readable media as recited in claim 11, wherein the information comprises a command element list, data that can be used to generate write data for commands in the authenticatable envelope, and a signature.

16. The one or more computer readable media as recited in claim 11, wherein the information comprises one or more digests, wherein each of said one or more digests is a digest of a non-volatile memory command, one or more non-volatile memory command parameters, and non-volatile memory command data that will be generated by the non-volatile memory.

17. The one or more computer-readable media as recited in claim 11, wherein the information comprises difference files.

18. The one or more computer-readable media as recited in claim 11, further comprising:
generating a signature; and
transmitting the signature to the device.

19. One or more computer-readable media embodying an envelope, the envelope comprising:
header information that comprises specification information for the envelope;
a command element list that comprises one or more commands, a list of command element parameters, and a list of command digests, wherein the command digests are digests of the one or more commands, the command element parameters, and data that will be associated with the commands when the commands are executed; and
a data section that comprises information to enable a device to generate write data for commands in the envelope.

20. The one or more computer-readable media as recited in claim 19, wherein the envelope further comprises write data generated from the one or more commands.

21. The one or more computer-readable media as recited in claim 19, wherein the envelope further comprises a signature.

22. The one or more computer-readable media as recited in claim 19, wherein the data section comprises one or more difference files.

23. The one or more computer-readable media as recited in claim 19, wherein the one or more commands are executed in a quasi-atomic fashion.

24. A system comprising:
a non-volatile memory,
one or more processors;
an antenna; and
one or more computer-readable media with instructions to update the non-volatile memory using an authenticatable envelope, the authenticatable envelope comprising:
header information that comprises specification information for the envelope;
a command element list that comprises one or more commands, a list of command element parameters, and a list of command digests, wherein the command digests are digests of the one or more commands, the command element parameters, and data that will be associated with the commands when the commands are executed; and
a data section that comprises information to enable a device to generate write data for commands in the envelope.

25. The system of claim 24, wherein the data section comprises one or more difference files.
